(19) United States
(12) Patent Application Publication
(10) Pub. No.: US 2026/0092663 A1
(43) Pub. Date: Apr. 2, 2026

(54) PIPING STRUCTURE FOR MACHINE TOOL

(71) Applicant: OKUMA CORPORATION, Niwa-Gun (JP)

(72) Inventor: Ayumi AKIMOTO, Niwa-Gun (JP)

(73) Assignee: OKUMA CORPORATION, Niwa-Gun (JP)

(21) Appl. No.: 19/335,104

(22) Filed: Sep. 22, 2025

(30) Foreign Application Priority Data
Oct. 2, 2024 (JP) 2024-173826

(51) Int. Cl. F16L 39/04; B23Q 11/10; F16L 39/02

(52) U.S. Cl. CPC F16L 39/04; B23Q 11/10; F16L 39/02

(57) ABSTRACT

A piping structure for a machine tool includes a structural body and at least one piping hose. The structural body includes a fixed portion having a mounting portion mountable into a predetermined receiving portion and a rotating portion pivotably attached to the fixed portion at an end of the fixed portion. The rotating portion has a rotation axis in a connection direction between the mounting portion and the receiving portion. The piping hose is inside the structural body and arranged to connect an end of the fixed portion on a mounting portion side to the rotating portion. One of the piping hoses is connected to the end of the fixed portion via one corresponding fixed-portion-side joint and connected to the rotating portion via one corresponding rotating-portion-side joint. At least one of the fixed-portion-side joints and the rotating-portion-side joints is pivotable.

### CROSS REFERENCE TO RELATED APPLICATION

This application claims the benefit of Japanese Patent Application Number 2024-173826 filed on October 2, 2024, the entirety of which is incorporated by reference.

### FIELD OF THE INVENTION

The disclosure relates to a piping structure for a machine tool, which is arranged inside a structure with a pivotable rotating portion, such as a replaceable main spindle attachment.

### BACKGROUND OF THE INVENTION

An example of a structure with a pivotable rotating portion is a replaceable main spindle head for a machine tool. The replaceable main spindle head (hereinafter referred to as a main spindle attachment) includes, for example, a main spindle attachment having a mechanism that allows the main spindle attachment to pivot the main spindle around the connection direction with the machine tool body, the so-called C-axis, as the pivot axis, as disclosed in JP 1998-145954 A. Even in such a main spindle attachment, various fluids such as air, oil, and cutting fluid need to be circulated from the machine tool body side to the main spindle side for the purposes such as improvement in drive and machining accuracy. Therefore, the main spindle attachment with a pivot axis like the C-axis in JP 1998-145954 A needs to include a piping structure therein that can withstand the pivot of the main spindle around the pivot axis. A conventional piping structure that can withstand the pivot of the main spindle around the pivot axis is a system in which piping hoses are passed around the pivot axis, such that the piping hoses can twist in accordance with the pivot of the main spindle.

However, simply passing the piping hoses around the pivot axis can cause the piping hoses themselves to twist as the main spindle pivots, and torsional load may shear the piping hoses. Therefore, measures have been taken to suppress the shearing of the piping hoses by lengthening the piping hoses to a certain length or more such that they can follow the pivot of the main spindle.

On the other hand, for larger pivot angles of the main spindle, longer piping hoses need to be arranged inside the main spindle attachment. Thus, increasing in size of the entire main spindle attachment is needed to contain the longer piping hoses, resulting in lower dynamic performance of the main spindle.

Other piping structures that can withstand the pivot of the main spindle around the pivot axis employs, for example, a system that uses a rotary joint that ties together a plurality of piping hoses, and a system that uses a so-called cable chain to guide the piping hoses. However, both the rotary joint and the cable chain are generally bulky structures. Thus, in either system, increasing in size of the entire main spindle attachment remains an issue, as in the case of lengthening the piping hoses.

Therefore, an objective of the disclosure is to provide a piping structure for a machine tool that allows reducing the size and weight of the structure while suppressing the shearing of the piping hoses.

### SUMMARY OF THE INVENTION

In order to solve the above-described problem, a first aspect of the disclosure provides a piping structure for a machine tool. The piping structure includes a structural body and at least one piping hose. The structural body includes a fixed portion having a mounting portion mountable into a predetermined receiving portion in the machine tool, and a rotating portion pivotably attached to the fixed portion at an end of the fixed portion that is opposite to the mounting portion, the rotating portion having a rotation axis in a connection direction between the mounting portion and the receiving portion. The piping hose is arranged inside the structural body. The piping hose is circulatable a fluid and arranged to connect an end of the fixed portion on a mounting portion side to a predetermined position of the rotating portion. One of the piping hose is connected to the end of the fixed portion via one corresponding fixed-portion-side joint, and connected to the predetermined position of the rotating portion via one corresponding rotating-portion-side joint. At least one of the fixed-portion-side joints and the rotating-portion-side joints is pivotable.

In another aspect of the above-described configuration of the disclosure, which is in the above-described configuration, at least one of the pivotable fixed-portion-side joints and the pivotable rotating-portion-side joints has pivot axis arranged parallel to the rotation axis of the rotating portion.

In another aspect of the above-described configuration of the disclosure, which is in the above-described configuration, when plurality of the piping hoses are inside the structural body, the fixed-portion-side joints and the rotating-portion-side joints are arranged on a same circumference centered on the rotation axis of the rotating portion.

In another aspect of the above-described configuration of the disclosure, which is in the above-described configuration, the piping hoses are bent near a connection point with the fixed portion or the rotating portion, and connected to the fixed portion or the rotating portion in a different direction from the rotation axis direction of the rotating portion.

According to the disclosure, in the piping structure, at least one of the fixed-portion-side joints that connect the fixed portion and the ends of the piping hoses of the fixed portion side and the rotating-portion-side joints that connect the rotating portion and the ends of the piping hoses on the rotating-portion-side are pivotable. Therefore, the piping hoses themselves to pivot following the pivot of the rotating portion. Accordingly, the piping structure can eliminate a torsion of the piping hoses caused by the pivot of the rotating portion and suppress the shearing of the piping hoses.

Furthermore, the pivotable fixed-portion-side joints and the pivotable rotating-portion-side joints has the pivot axes arranged parallel to the rotation axis of the rotating portion, and when plurality of the piping hoses are inside the structural body, at least one of the fixed-portion-side joints and the rotating-portion-side joints is arranged on the same circumference centered on the rotation axis of the rotating portion. Accordingly, the piping structure can control the occurrence of the torsional load in each piping hose, even if the plurality of piping hoses become entangled when the rotating portion pivots.

In addition, by making the connection direction between the fixed portion or the rotating portion and the ends of the piping hoses on the fixed portion side or the rotating-portion-side different from the rotation axis direction of the rotating portion, the piping structure can absorb the expansion and contraction of the piping hoses caused by the entanglement of the piping hoses with each other, and reduce the load generated in each piping hose.

### BRIEF DESCRIPTION OF THE DRAWINGS

FIG. 1 illustrates a part of a machine tool mounted with a main spindle attachment having a pivotable rotating portion.

FIG. 2 illustrates a piping structure according to the disclosure when the rotating portion is not pivoted.

FIG. 3 illustrates a piping structure according to the disclosure when the rotating portion is pivoted.

### DETAILED DESCRIPTION OF THE INVENTION

Embodiments of the disclosure will be described below with reference to the drawings.

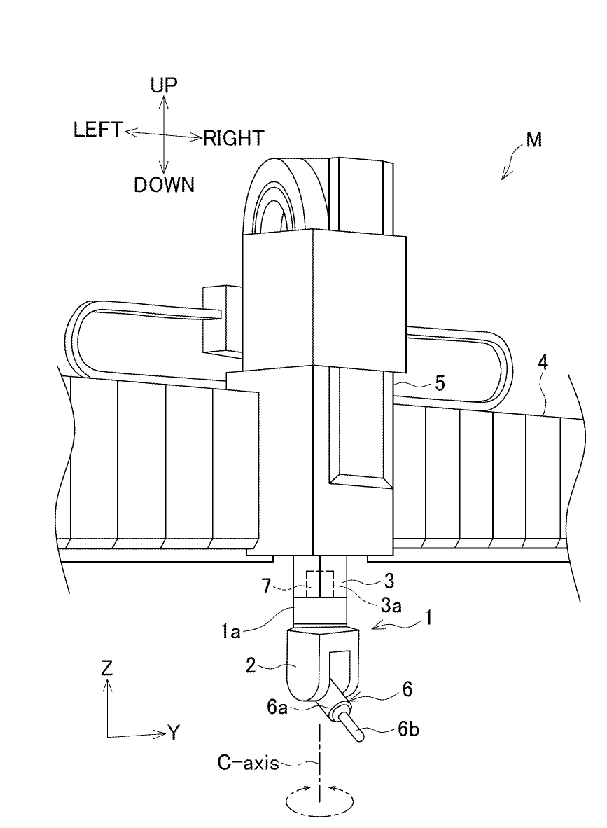

FIG. 1 illustrates a part of a machine tool mounted with a main spindle attachment having a pivotable rotating portion.

As illustrated in FIG. 1, the machining center M as a machine tool includes a saddle 5 that is provided on a cross rail 4 to be movable in a left-right direction as a Y-axis direction. In addition, a main spindle ram 3 is supported at a lower end of the saddle 5 to be movable in an upper and lower direction as a Z-axis direction. Additionally, a main spindle attachment 1 is detachably attached to a lower end of the main spindle ram 3.

The main spindle attachment 1 is mounted by inserting a mounting portion 7 provided on a fixed portion 1a, which is an end on the main spindle ram 3 side, into a receiving portion 3a formed at the lower end of the main spindle ram 3. In addition, the main spindle attachment 1 includes a frame 2 at its lower end, which is the end opposite to the mounting portion 7. The frame 2 acts as a rotating portion pivotable around the C-axis as the rotation axis. The C-axis is parallel to the Z-axis with respect to the main spindle ram 3. The frame 2 includes a main spindle head 6 with a main spindle 6a that holds a tool 6b.

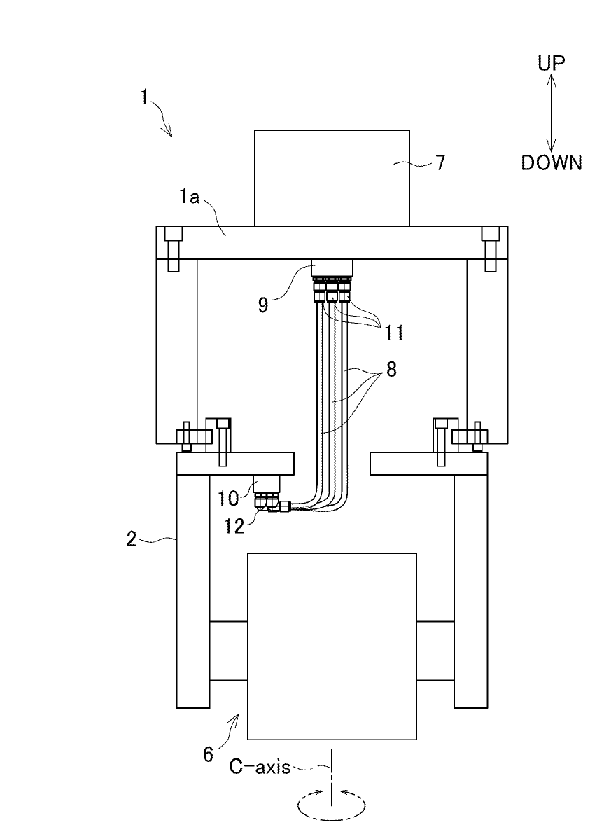

FIG. 2 illustrates a piping structure according to the disclosure when the rotating portion is not pivoted.

As illustrated in FIG. 2, the main spindle attachment 1 includes piping hoses 8 therein for circulating various fluids such as air, oil, and cutting fluid for the purposes such as improvement in drive and machining accuracy. The number of piping hoses 8 provided corresponds to the number of fluids to be circulated. In addition, in the embodiment, it is assumed that four types of fluids will be circulated through the main spindle attachment 1, and the four piping hoses 8 are arranged to connect an inflow portion 9 provided on the fixed portion 1a and an outflow portion 10 provided on the lower surface of the upper portion of the frame 2.

The piping hoses 8 and the inflow portion 9 are connected via fixed-portion-side joints 11. The fixed-portion-side joints 11 can pivot around the pivot axis parallel to the rotation axis of the frame 2, namely, the C-axis.

Additionally, the four piping hoses 8 are arranged on the same circumference centered on the C-axis via the fixed-portion-side joints 11.

The piping hoses 8 and the outflow portion 10 are connected via generally L-shaped rotating-portion-side joints 12. In the embodiment, since the rotating-portion-side joints 12 are generally L-shaped and the outflow portion 10 is on the upper side of the frame 2, the piping hoses 8 are bent near the outflow portion 10 and connected to the rotating-portion-side joints 12, i.e., the frame 2 in a different direction from the C-axis which is the rotation axis of the frame 2.

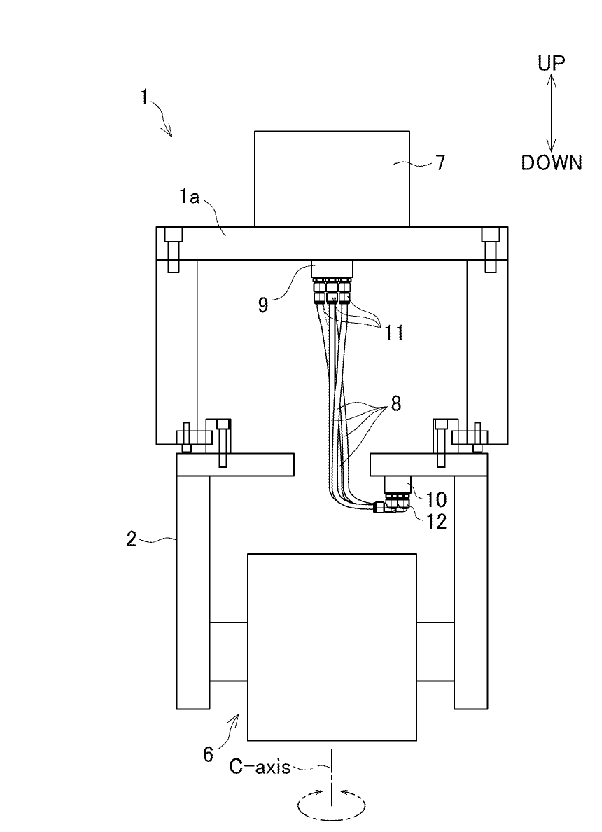

FIG. 3 illustrates a piping structure according to the disclosure when the rotating portion is pivoted.

When the main spindle attachment 1 is not pivoted, the piping hoses 8 hang down from the lower ends of the fixed-portion-side joints 11, i.e., the inflow portion 9 in parallel with the C-axis, bend near the outflow portion 10, and then connect to the rotating-portion-side joints 12, as illustrated in FIG. 2. In this state, no torsional load occurs in the piping hoses 8.

On the other hand, the frame 2 pivoted 180 degrees around the C-axis is illustrated in FIG. 3. If the fixed-portion-side joints 11 were joints that did not pivot, a corresponding torsional load would occur in each of the piping hoses 8. However, since the fixed-portion-side joints 11 can pivot around a pivot axis parallel to the C-axis, the fixed-portion-side joints 11 and thus the piping hoses 8 themselves can pivot following the pivot of the frame 2. This can eliminate the torsion of the piping hoses 8 caused by the pivot of the frame 2 and suppress the shearing of the piping hoses 8.

Additionally, the piping hoses 8 are arranged on the same circumference centered on the C-axis, which can control the occurrence of the torsional load in each of the piping hoses 8, even if the piping hoses 8 become entangled caused by the pivot of the frame 2.

In addition, since the connection direction between the rotating-portion-side joint 12 for connection with the frame 2 and the ends of the piping hoses 8 on the frame 2 side is different from a C-axis direction, it is possible to absorb the expansion and contraction of the piping hoses 8 caused by the entanglement of the piping hoses 8 when the frame 2 pivots, and reduce the load generated in each of the piping hoses 8.

The piping structure of the above configuration includes the main spindle attachment 1. The main spindle attachment 1 includes the fixed portion 1a having the mounting portion 7 mountable into the receiving portion 3a of the main spindle ram 3 in the machining center M, and the frame 2 pivotably attached to the fixed portion 1a at the end of the fixed portion 1a that is opposite to the mounting portion 7. The frame 2 has a rotation axis in a connection direction between the mounting portion 7 and the receiving portion 3a, namely, the C-axis. The piping structure also includes the piping hoses 8 inside the main spindle attachment 1. The piping hoses 8 are capable of circulating a fluid. The piping hoses 8 are arranged to connect the inflow portion 9 provided at the end of the fixed portion 1a on the mounting portion 7 side to the outflow portion 10 provided on the upper portion of the frame 2. The piping hoses 8 are connected to the inflow portion 9 via the one corresponding fixed-portion-side joint 11. The piping hoses 8 are connected to the outflow portion 10 via the one rotating-portion-side joint 12. The fixed-portion-side joint 11 is capable of pivoting.

Accordingly, the connection of the inflow portion 9 of the fixed portion 1a with the ends of the piping hoses 8 on the fixed portion 1a side via the pivotable fixed-portion-side joint 11 allows the piping hoses 8 themselves to pivot following the pivot of the frame 2. This can eliminate the torsion of the piping hoses 8 caused by the pivot of the frame 2 and suppress the shearing of the piping hoses 8.

Additionally, the fixed-portion-side joint 11 has a pivot axis arranged parallel to the rotation axis of the frame 2, namely, the C-axis, and the four piping hoses 8 are arranged on the same circumference centered on the C-axis via the fixed-portion-side joint 11. This can control the occurrence of the torsional load in each of the piping hoses 8, even when the piping hoses 8 become entangled when the frame 2 pivots.

In addition, since the connection direction between the rotating-portion-side joint 12 for connection with the frame 2 and the ends of the piping hoses 8 on the frame 2 side is a different direction from the C-axis direction, it is possible to absorb the expansion and contraction of the piping hoses 8 caused by the entanglement of the piping hoses 8 and reduce the load generated in each of the piping hoses 8.

Furthermore, the configuration of the piping structure according to the disclosure is not limited to the aspects described in the above embodiments, and can be modified as necessary without departing from the spirit of the invention.

For example, the structural body is not limited to the main spindle attachment, and any structural body can be used that includes a rotating portion pivoting relative to a fixed portion and is capable of including a piping hose therein.

In addition, the machine tool may be others than the machining center.

Furthermore, a non-pivoting joint may be used as the fixed-portion-side joint and a pivotable joint may be used as the rotating-portion-side joint, or pivotable joints may be used as both the fixed-portion-side joint and the rotating-portion-side joint. In these cases, in order to facilitate the pivot of the piping hoses themselves, it is preferable to arrange the outflow portion on the upper surface of the upper portion of the rotating portion, rather than on the lower surface of the upper portion of the rotating portion as illustrated in FIG. 2.

Additionally, the pivotable fixed-portion-side joint and rotating-portion-side joint can be of any specifications that can make the piping hoses pivotable.

Furthermore, as described in the above embodiments, it is preferable to arrange either the fixed portion or the rotating portion such that the piping hoses are bent near the fixed portion or the rotating portion, but the disclosure is not limited thereto.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A piping structure for a machine tool, comprising:
a structural body including a fixed portion having a mounting portion mountable into a predetermined receiving portion in the machine tool, and a rotating portion pivotably attached to the fixed portion at an end of the fixed portion that is opposite to the mounting portion, the rotating portion having a rotation axis in a connection direction between the mounting portion and the receiving portion; and
at least one piping hose inside the structural body, the piping hose being circulatable a fluid and arranged to connect an end of the fixed portion on a mounting portion side to a predetermined position of the rotating portion, wherein
one of the piping hoses is connected to the end of the fixed portion via one corresponding fixed-portion-side joint, and connected to the predetermined position of the rotating portion via one corresponding rotating-portion-side joint, and
at least one of the fixed-portion-side joints and the rotating-portion-side joints is pivotable.

2. The piping structure for a machine tool according to claim 1, wherein
at least one of the pivotable fixed-portion-side joints and the pivotable rotating-portion-side joints has a pivot axis arranged parallel to the rotation axis of the rotating portion.

3. The piping structure for a machine tool according to claim 2, wherein
when plurality of the piping hoses are inside the structural body, the fixed-portion-side joints and the rotating-portion-side joints are arranged on a same circumference centered on the rotation axis of the rotating portion.

4. The piping structure for a machine tool according to claim 1, wherein
the piping hoses are bent near a connection point with the fixed portion or the rotating portion, and connected to the fixed portion or the rotating portion in a different direction from the rotation axis direction of the rotating portion.
